(19) United States
(12) Patent Application Publication
(10) Pub. No.: US 2007/0111068 A1
(43) Pub. Date: May 17, 2007

(54) COMPLIANT FEED TUBES FOR PLANAR SOLID OXIDE FUEL CELL SYSTEMS

(75) Inventors: Sauri Gudlavalleti, Albany, NY (US); Peter Zheng, Rancho Palos Verdes, CA (US); James D. Powers, Santa Monica, CA (US); Dacong Weng, Rancho Palos Verdes, CA (US); Jie Guan, Torrence, CA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/164,295

(22) Filed: Nov. 17, 2005

(51) Int. Cl. H01M 8/12; H01M 2/08; H01M 8/24; C04B 35/64

(52) U.S. Cl. 429/32; 429/38; 429/35; 264/618

(57) ABSTRACT

A solid oxide fuel cell system. The solid oxide fuel cell system may include a number of fuel cells placed under load in a fuel cell stack, a number of manifold slices placed under load in a manifold column, and a number of compliant feed tubes connecting the fuel cells and the manifold slices.

### FEDERAL RESEARCH STATEMENT

This invention was made with Government support under Contract No. DE-FC26-01 NT41245 awarded by the Department of Energy. The Government may have certain rights in this invention.

### TECHNICAL FIELD

The present invention relates generally to power systems using solid oxide fuel cells and more particularly relates to compliant gas feed tubes for an external manifold and a solid oxide fuel cell stack.

### BACKGROUND OF THE INVENTION

A fuel cell is a galvanic conversion device that electrochemically reacts a fuel with an oxidant to generate a direct current. The fuel cell generally includes a cathode material, an electrolyte material, and an anode material. The electrolyte material is a non-porous material sandwiched between the cathode and the anode materials. The anode and the cathode generally will be referred to as electrodes. An individual electrochemical cell usually generates a relatively small voltage. Thus, the individual electrochemical cells are connected together in series to form a stack so as to achieve higher voltages that are practically useful.

The anode, the electrolyte, and the cathode structures are substantially planar, or flat, in a planar fuel cell. To create a fuel cell stack, an interconnecting member is used to connect the adjacent fuel cells together in electrical series. A fuel cell stack is typically accompanied by one or more master manifolds so as to supply fuel and/or oxidant to the stack and to remove the spent fuel or air as well. Most fuel cell stack designs typically allow the fuel and the oxidant flow chambers of each cell in the stack to communicate individually with the corresponding master manifold. In internally manifolded fuel cell stack designs, the master manifolds are integral with the fuel cell stack and may be directly connected to the individual flow chambers. In externally manifolded fuel cell stack designs, the master manifold is substantially separated from the fuel cell stack and feed tubes or passages are provided to connect the master manifold to the cells in the fuel cell stack. One or more feed tubes may carry the same fluid (fuel or oxidant) to each fuel cell or the same feed tube may supply one or more fuel cells. Feed tubes may similarly be used to carry spent fuel or oxidant away from the fuel cell into an appropriate exhaust master manifold. The present invention relates to the design of such feed tubes in an externally manifolded fuel cell stack.

An external master manifold may be formed a number of ways. In one way, the manifold may include a pre-fabricated tube. In another method, stacking individual manifold “slices” may form the master manifold. In such a construction, appropriate manifold seals are required between these individual manifold slices to avoid leakage of the fluid carried through the master manifold.

A compressive load normal to the plane of the cells in a solid oxide fuel cell stack (the axial direction) generally is used. This axial compressive load performs several functions at three interfaces: (1) reduces area specific resistance by maintaining contact between a cell and an interconnect, (2) reduces leakage by maintaining compression on the perimeter seal of a cell, and (3) reduces leakage by maintaining compression on the manifold seal. Given the variety of materials used at each of these interfaces, and the variation in their behavior at different times in the stack lifecycle, the amount of axial deflection at each interface is different. Specific issues include manufacturing tolerances, seal compression, loss of interfacial filler materials (bond paste), relative thermal expansion, etc. Several of these conditions are reoccurring while some are only present at the initial assembly of the stack. Varying axial loads therefore may be required at each interface at various times. Excessive compression on the cell could lead to cell failure while insufficient compression could lead to reduced performance.

There is a need therefore for a means to apply an axial load to a solid oxide fuel cell stack while accommodating the differing characteristics of the elements that make up the stack as a whole. The load should be applied without compromising system efficiency.

### SUMMARY OF THE INVENTION

The present application thus describes a solid oxide fuel cell system. The solid oxide fuel cell system may include a number of fuel cells placed under load in a fuel cell stack, a number of manifold slices placed under load in a manifold column, and a number of compliant feed tubes connecting the fuel cells and the manifold slices.

The manifold column may be placed under load separately from the fuel cell stack. The mechanical load applied to the fuel cell stack and the mechanical load applied to the manifold column may be substantially isolated by the number of compliant feed tubes. The manifold column may include a number of seals with one of the seals positioned between a pair of the manifolds. The seals may include mica or vermiculite based gaskets. One or more of the compliant feed tubes electrically isolates the respective fuel cell and the manifold slice. The manifold slices may be integral with or separate from the compliant feed tubes. The fuel cells include a number of interconnects such that the interconnects are in communication with the compliant feed tubes.

The compliant feed tubes may include a metallic or ceramic material in whole or in part. The compliant feed tubes may include a corrugated material or a bent feed tube. The manifold slices may have a coating of an alumina, yttria stabilized zirconia, or a ceramic.

The present application further describes a method of manufacturing a fuel cell system. The method may include assembling a sub-stack of a number of fuel cells, a number of manifold slices, and a number of compliant feed tubes, heating the sub-stack such that the number of compliant feed tubes sets, and assembling the sub-stacks into the solid oxide fuel cell system. The method further may include placing the fuel cells and the manifold slices under load independently, isolating the mechanical load applied to the manifold and to the fuel cell stack by deflection of the compliant feed tubes, and integrally fabricating the manifolds and the compliant feed tubes.

The present application further may describe a solid oxide fuel cell system. The solid oxide fuel cell system may include a number of fuel cells placed under load in a fuel cell stack and a number of manifold slices placed under load in a manifold column such that the manifold column is placed under load separately from the fuel cell stack. A number of compliant feed tubes may connect the fuel cells and the manifold slices. The compliant feed tubes may include a metallic or ceramic material in whole or in part. The load applied to the fuel cell stack and load applied to the manifold column may be substantially isolated by the compliant feed tubes.

These and other features of the present application will become apparent to one of ordinary skill in the art upon review of the following detailed description when taken in conjunction with the drawings and the appended claims.

### BRIEF DESCRIPTION OF THE DRAWING

FIG. 1 is a perspective view of a solid oxide fuel cell stack as is described herein.

FIG. 2 is a perspective view of an alternative embodiment of a solid oxide fuel cell stack.

### DETAILED DESCRIPTION

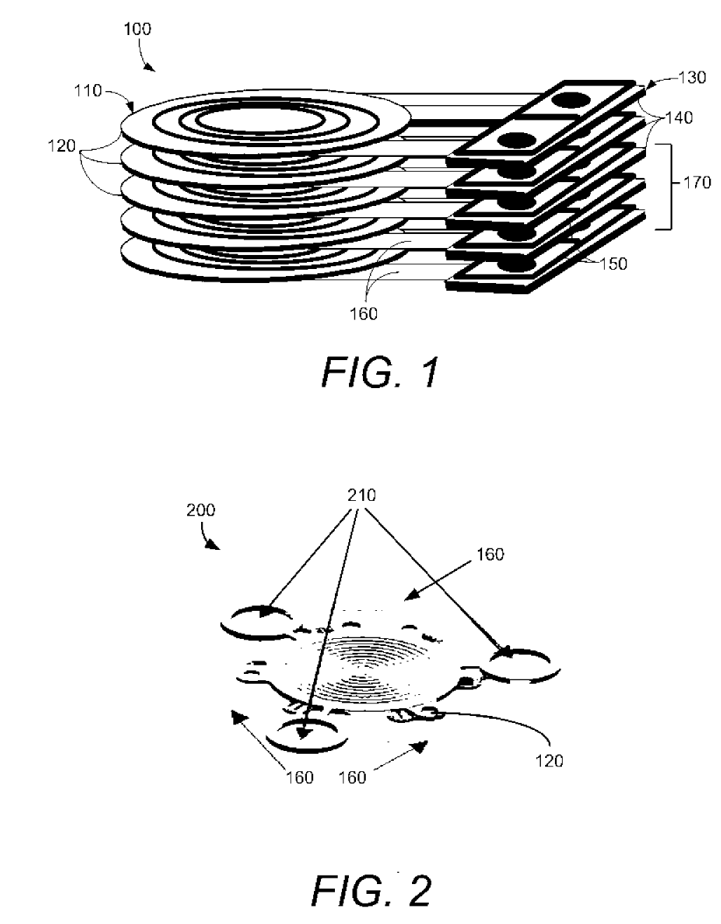

Referring now to the drawing, in which like numerals reflect like elements throughout the view, FIG. 1 shows a solid oxide fuel cell (“SOFC”) system 100 as is described herein. The SOFC system 100 includes a fuel cell stack 110 with a number of fuel cells 120. The SOFC stack 110 may have any desired number of fuel cells 120 therein. The fuel cells 120 may be of largely conventional design. The fuel cells 120 within the SOFC stack 110 may be connected by a number of interconnects. As is well known, the interconnects may be two or more layers of metal joined together to form flow passages for fuel and/or oxidant.

The SOFC system 100 may have a master manifold 130 positioned adjacent to the SOFC stack 110. The master manifold 130 may have any number of manifold slices 140 positioned therein. The manifold slices 140 are used to deliver fuel and oxidant to the interconnects of the fuel cells 120. Generally, one manifold slice 140 is used for each of the fuel cells 110. It is possible to have one manifold slice 140 supply several fuel cells 120 as well.

A seal 150 may be positioned within each of the manifold slices 140 of the manifold column 130. The seals 150 may be high temperature compressive gaskets such as mica or vermiculite based gaskets. Glass seals also may be used. Other types of high temperature resistant materials may be used herein. The seals 150 also may be made out of an insulating material so as to provide electrical insulation. Alternatively, the surface of the manifold slices 140 may be covered with an insulating coating such as alumina, yttria stabilized zirconia, a general ceramic, or another appropriate type of coating material resistant to high temperature operation.

The fuel cells 120 of the SOFC stack 110 may be in communication with the manifold slices 140 of the master manifolds 130 via a number of compliant feed tubes 160. Specifically, each of the fuel cells 120 may be in communication with the master manifold 130 via one or more of the compliant feed tubes 160. The compliant feed tubes 160 may include metallic or ceramic tubes or tubes that are metallic in some regions and ceramic in other regions along the length. The compliant feed tubes 160 may be circular or non-circular in cross-section. The compliant feed tubes 160 may deliver fuel or oxidant from the appropriate master manifold 130 to the fuel cells 120 or deliver spent fuel or air from the fuel cell 120 to the appropriate master manifold 130. The compliant nature of the feed tubes 160 substantially isolates the mechanical loads applied to the SOFC stack 110 and the manifold column 130.

The required compliance in the feed tubes 160 may be achieved by one of several methods, including but not limited to: appropriate design of the length and cross-section of the feed tubes 160, corrugating at least a portion of the length of the feed tubes 160, or providing one or more appropriately designed bends in the feed tubes 160. Other methods may be used herein. The compliant feed tubes 160 also may provide electrical insulation between the fuel cell 120 and the master manifold 130.

The compliant feed tubes 160 may be integral with the manifold slices 140 of the manifold column 130. Alternatively, the feed tubes 160 may be separately fabricated and then attached to the fuel cells 120 on one end and the manifold slices 140 on the other end. One or more feed tubes 160 may arise from each manifold slice 140. Additional layers of feed tubes 160 and manifold slices 140 may be stacked on top of one another to form the master manifold or manifold column 130. The seals 150 may be placed between the manifold slices 140 in order to prevent leakage of gas from the master manifold 130 formed by stacking the manifold slices 140. Likewise, the other end of each of the compliant feed tubes 160 may be attached to a fuel cell 120. Additional fuel cells 120 may be stacked one on top of the other so as to form the SOFC stack 110. The appropriate mechanical load then may be applied to the SOFC stack 110 and the manifold column 130. The master manifold 130 may be placed under load independently of the SOFC stack 110.

Instead of completing the entire SOFC stack 110 or the entire manifold column 130, a sub-stack 170 may be created. The sub-stack 170 then may be heated to cause at least some of the one time relative axial deflections between the SOFC stack 110 and the manifold column 130. This heating also may cause the compliant feed tubes 160 to develop a permanent set corresponding to this deflection. The sub-stacks 170 then may be assembled into a full stack system 100. The use of the sub-stacks 170 limits or reduces the mechanical load required to deflect the compliant feed tubes 160.

The use of the external manifold column 130 and the compliant feed tubes 160 thus allows the fuel cell stack 110 to be isolated of the mechanical loads and deflections. The compliant feed tubes 160 also may have a permanent set in the final state such that deflection loads may be relieved. The compliant feed tubes 160 and the manifold column 130 also may be integrally fabricated so as to reduce manufacturing steps and the number of joints required. The use of the external manifold column 130 also allows for a detachable and durable seal.

FIG. 2 shows a further embodiment of a SOFC stack 200. In this embodiment, the manifold column 130 is not a unitary structure. Rather, a number of separate manifold slices 210 may be used. Specifically, three (3) manifold slices 210 are shown surrounding the fuel cell 120. The fuel cell 120 thus is connected three compliant feed tubes 160. The manifold slices 210 thus may be stacked into three (3) manifold columns. One column may provide fuel inlet, one column may provide fuel outlet, and one column may provide air inlet. Any desired number of manifold slices 210 and columns may be used.

It should be apparent that the foregoing relates only to the preferred embodiments of the present application and that numerous changes and modifications may be made herein by one of ordinary skill in the art without departing from the general spirit and scope of the invention as defined by the following claims and the equivalents thereof.

What is claimed is:

1. A solid oxide fuel cell system, comprising:
a plurality of fuel cells placed under load in a fuel cell stack;
a plurality of manifold slices placed under load in a manifold column; and
a plurality of compliant feed tubes connecting the plurality of fuel cells and the plurality of manifold slices.

2. The solid oxide fuel cell system of claim 1, wherein the manifold column is placed under load separately from the fuel cell stack.

3. The solid oxide fuel cell system of claim 1, wherein the manifold column comprises a plurality of seals and wherein one of the plurality of seals is positioned between a pair of the plurality of manifold slices.

4. The solid oxide fuel cell system of claim 3, wherein the plurality of seals comprises mica or vermiculite based gaskets.

5. The solid oxide fuel cell of claim 1, wherein the plurality of seals comprises an electrically insulating material.

6. The solid oxide fuel cell of claim 1, wherein one or more of the compliant feed tubes electrically isolates the respective fuel cell and the manifold slice.

7. The solid oxide fuel cell of claim 1, wherein the plurality of compliant feed tubes comprises a metallic or ceramic material in whole or in part.

8. The solid oxide fuel cell of claim 1, wherein a mechanical load applied to the fuel cell stack and a mechanical load applied to the manifold column are substantially isolated by the plurality of compliant feed tubes.

9. The solid oxide fuel cell of claim 1, wherein the plurality of manifold slices is integral with the plurality of compliant feed tubes.

10. The solid oxide fuel cell of claim 1, wherein the plurality of manifold slices is separate from the plurality of complaint feed tubes.

11. The solid oxide fuel cell of claim 1, wherein the plurality of compliant feed tubes comprises a corrugated material.

12. The solid oxide fuel cell of claim 1, wherein the plurality of compliant feed tubes comprises a bent feed tube.

13. The solid oxide fuel cell of claim 1, wherein the plurality of manifold slices comprises a coating of an alumina, yttria stabilized zirconia, or a ceramic.

14. The solid oxide fuel cell of claim 1, wherein the plurality of fuel cells comprises a plurality of interconnects and wherein the plurality of interconnects are in communication with the plurality of compliant feed tubes.

15. A method of manufacturing a solid oxide fuel cell system, comprising:
assembling a sub-stack of a plurality of fuel cells, a plurality of manifold slices, and a plurality of compliant feed tubes;
heating the sub-stack such that the plurality of compliant feed tubes sets; and assembling the plurality of sub-stacks into the solid oxide fuel cell system.

16. The method of claim 15, further comprising placing the plurality of fuel cells and the plurality of manifold slices under load independently.

17. The method claim 15, further comprising isolating a mechanical load applied to the plurality of manifold slices and to the plurality of fuel cells by deflection of the plurality of compliant feed tubes.

18. The method of claim 15, further comprising integrally fabricating the plurality of manifold slices and the plurality of compliant feed tubes.

19. A solid oxide fuel cell system, comprising:
a plurality of fuel cells placed under load in a fuel cell stack;
a plurality of manifold slices placed under load in a manifold column; wherein the manifold column is placed under load separately from the fuel cell stack; and
a plurality of compliant feed tubes connecting the plurality of fuel cells and the plurality of manifold slices;
wherein the plurality of compliant feed tubes comprises a metallic or ceramic material in whole or in part.

20. The solid oxide fuel cell of claim 19, wherein the load applied to the fuel cell stack and load applied to the manifold column are substantially isolated by the plurality of compliant feed tubes.
